(19) United States
(12) Patent Application Publication
(10) Pub. No.: US 2026/0326579 A1
(43) Pub. Date: Oct. 22, 2026

(54) SOLID STATE Li2CaCl4 AND Li3Ca2Cl7 ELECTROLYTE MATERIALS WITH HIGH IONIC CONDUCTIVITY

(71) Applicant: Samsung Electronics Co., Ltd., Suwon-si (KR)

(72) Inventors: Chuhong Wang, Lexington, MA (US); Qingjie Li, Arlington, MA (US); Zijian Cai, Cambridge, MA (US); Yan Wang, Brookline, MA (US)

(21) Appl. No.: 19/364,335

(22) Filed: Oct. 21, 2025

Related U.S. Application Data
(60) Provisional application No. 63/789,702, filed on Apr. 16, 2025.

(51) Int. Cl. B60L 50/64; B60K 1/04; B60L 7/10; B60L 53/16; B60L 58/12; C01F 11/00; H01M 10/0525; H01M 10/0562; H01M 10/42; H01M 10/46; H01M 10/48

(52) U.S. Cl. CPC B60L 50/64; B60K 1/04; B60L 7/10; B60L 53/16; B60L 58/12; C01F 11/00; H01M 10/0525; H01M 10/0562; H01M 10/425; H01M 10/46; H01M 10/486; H01M 10/488; B60L 2240/545; B60L 2240/547; B60L 2250/16; C01P 2002/76; C01P 2002/77; C01P 2006/40; C01P 2006/90; H01M 2010/4271; H01M 2220/20; H01M 2300/008

(57) ABSTRACT

Electrolyte materials having the formulas Li₂CaCl₄ or Li₃Ca₂Cl₇ are provided, wherein the electrolyte material crystallizes in a space group selected from the group consisting of Cm, Imma, Cmmm, and P1. A solid-state battery comprising Li₂CaCl₄ or Li₃Ca₂Cl₇ electrolyte materials is provided. Methods for making Li₂CaCl₄ and Li₃Ca₂Cl₇ electrolyte materials are also provided.

### CROSS-REFERENCE TO RELATED APPLICATION

This application claims priority to U.S. Provisional Application No. 63/789,702, filed on Apr. 16, 2025, the contents of which in its entirety are herein incorporated by reference.

### TECHNICAL FIELD

The present disclosure relates to synthesized electrolyte materials, batteries comprising the electrolyte material, and methods of making the electrolyte material. The electrolyte materials crystallize in a particular space group and are capable of achieving a high Li-ion conductivity.

### BACKGROUND

The quest for next-generation energy-storage technologies has pivoted towards all-solid-state batteries (ASSBs), primarily owing to their potential for enhanced safety and energy density. Halide solid-state electrolytes (HSEs) are believed to be advantageous for ASSB technology due to their high oxidation stability, good deformability and low processing temperature. Their unique anion chemistry enables a balance between ionic conductivity and interfacial stability. Simulation studies and experimental validations have shown that HSEs can achieve ionic conductivities comparable to those of sulfide solid-state electrolytes (>10 mS cm⁻¹).

Known materials for HSEs are often made with expensive elements, some with rare-earth elements. It is desirable to find new materials with inexpensive metals to accelerate industry applications as well as to improve the ionic conductivity.

### SUMMARY

Aspects of the present disclosure provide improved halide solid-state electrolytes (HSEs) that improve ionic conductivity at a lower cost.

In some embodiments, Li₂CaCl₄ and Li₃Ca₂Cl₇ electrolyte materials are provided, wherein the electrolyte material crystallizes in a space group selected from the group consisting of Cm, Imma, Cmmm, and P1.

In some embodiments, a solid-state battery comprising Li₂CaCl₄ or Li₃Ca₂Cl₇ electrolyte materials is provided.

In some embodiments, an electric vehicle is provided, comprising an electric motor configure to propel the vehicle, and the solid-state battery.

In some embodiments, methods of making a Li₂CaCl₄ or Li₃Ca₂Cl₇ electrolyte material are provided, comprising mixing LiCl and CaCl₂, and sintering the mixture to thereby produce the Li₂CaCl₄ or Li₃Ca₂Cl₇ electrolyte material.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic diagram of a solid-state battery including the electrolyte material of the present disclosure,

FIG. 2 is a flow chart illustrating a process for making the electrolyte material of the present disclosure,

FIG. 3 illustrates crystalline space groups for electrolyte materials of the present disclosure, and

FIG. 4 is a schematic diagram illustrating aspects of an electric vehicle comprising the solid-state battery of the present disclosure.

### DETAILED DESCRIPTION

Unless otherwise defined, all terms used herein have the same meaning as commonly understood by one of ordinary skill in the art. Further, all terms should be interpreted as having a meaning that is consistent with their meaning in the context of the relevant art and this disclosure and will not be interpreted in an idealized or overly formal sense unless expressly so defined herein.

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps and those that do not materially affect the basic and novel characteristic(s) of the claimed invention. Thus, the term “consisting essentially of” as used herein should not be interpreted as equivalent to “comprising.”

It will also be understood that, as used herein, the terms “example,” “exemplary,” and grammatical variations thereof are intended to refer to non-limiting examples and/or variant embodiments discussed herein, and are not intended to indicate preference for one or more embodiments discussed herein compared to one or more other embodiments.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

The terminology used herein is for the purpose of describing particular embodiments only and is not intended to be limiting of embodiments. The terms “first,” “second,” etc., may be used herein merely to distinguish one component, layer, direction, etc. from another. When components or layers are referred to herein as “directly” on, or “in direct contact” or “directly connected,” no intervening components or layers are present.

Aspects of the present disclosure provide improved solid-state electrolytes that improve ionic conductivity at a lower cost. In some embodiments, the materials described herein are prepared with less expensive metals than many high ion conductivity materials made with expensive elements, including those made with rare-earth elements. Accordingly, the electrolyte materials disclosed herein provide an improvement in cost over materials made with high cost elements, while retaining desirable high Li-ion conductivity. This disclosure presents compositions according to the formula Li₂CaCl₄ or the formula Li₃Ca₂Cl₇.

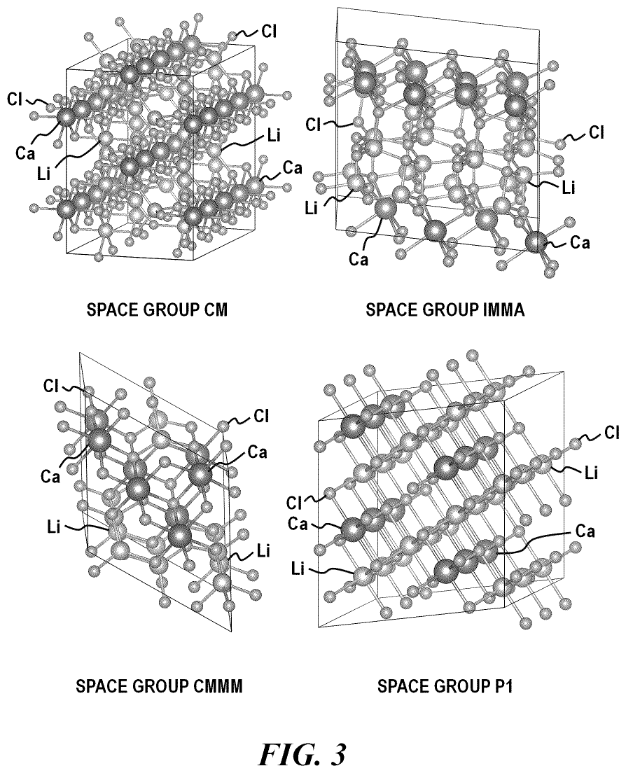

In some embodiments, an electrolyte material according to the formula Li₂CaCl₄ or the formula Li₃Ca₂Cl₇ is provided. This electrolyte material crystallizes in a space group selected from the group consisting of Cm, Imma, Cmmm, and P1. The geometry of these space groups is illustrated in FIG. 3.

In some embodiments, the conductivity of the electrolyte material is at least 10 millsiemens/centimeter (mS/cm) when measured at a temperature of 300 K using electrochemical impedance spectroscopy. For instance, in some embodiments, the electrolyte material may have a conductivity of at least 20 mS/cm, at least 30 mS/cm, at least 40 mS/cm, or at least 50 mS/cm, when measured at 300 K using electrochemical impedance spectroscopy. This high conductivity reduces the internal impedance of the battery and enables the all solid-state battery to be charged, and discharged, faster. This is advantageous for end uses such as electric vehicles and drones which require fast charging and discharging of the onboard battery.

The electrolyte materials disclosed herein also exhibit good thermodynamic stability or metastability. Thermodynamic stability or metastability may be evaluated with reference to the energy above hull (Eₕᵤₗₗ) measured for a given material, wherein a lower Eₕᵤₗₗ indicates a material which is more thermodynamically stable or metastable. In some embodiments, the electrolyte material disclosed herein has an energy above hull from about 25 meV/atom to about 70meV/atom.

Further, the electrolyte materials disclosed also exhibit relatively low hardness. The hardness value of a material is inversely related to its deformability. Thus, a material such as the present solid electrolyte having a low hardness value also has a good deformability. This good deformability allows the solid electrolyte material to be readily shaped when forming a battery.

In some embodiments, the electrolyte materials have a Vickers hardness value from about 0.25 GPa to about 1.6 GPa, when measured using a universal testing machine (UTM).

By using the solid-state electrolyte material disclosed herein, an all solid-state battery with desirable charge characteristics can be achieved. In particular, the solid-state electrolyte material exhibits a high conductivity of at least 10 millisiemens/centimeter (mS/cm) or greater. In some embodiments, the conductivity may be at least 50 mS/cm or even greater. This high conductivity enables the all solid-state battery to be charged, and discharged, faster.

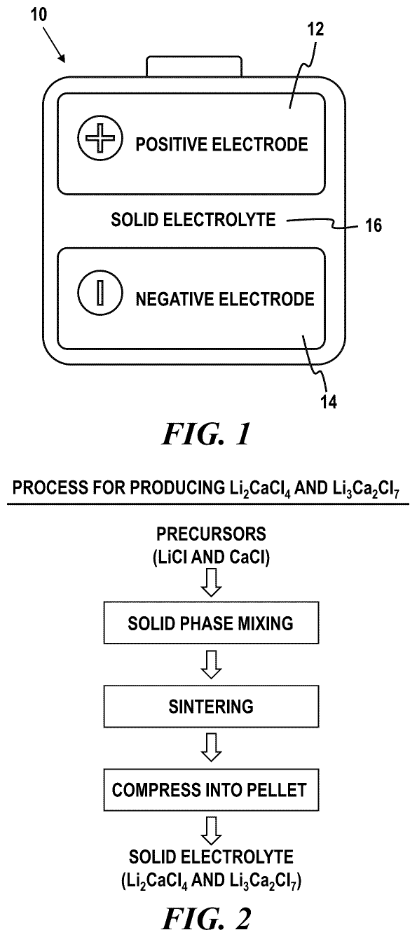

In some embodiments, a solid-state battery is provided, comprising Li₂CaCl₄ or Li₃Ca₂Cl₇ electrolyte materials which crystallize in a space group selected from the group consisting of Cm, Imma, Cmmm, and P1. In some embodiments, the battery 10 comprises a positive electrode 12, a negative electrode 14, and the solid-state electrolyte material 16 between the positive electrode and the negative electrode, as shown in FIG. 1. In some embodiments, at least one of the positive electrode, the electrolyte layer, and the negative electrode includes the solid electrolyte material. The shape of the solid-state electrolyte material is not particularly limited and may be, for example, particles that may be laminated, formed into pellets or plates.

In an example embodiment, the battery may be manufactured by injecting a Li₂CaCl₄ or Li₃Ca₂Cl₇ electrolyte material into an electrode assembly including a cathode, an anode, and a separator disposed between the cathode and the anode. The cathode and/or the anode may comprise the electrolyte material. In an example embodiment, the cathode and/or anode may be each manufactured by mixing the solid-state electrolyte material, a binder, and a conducting agent with a solvent to prepare a slurry, coating the slurry on a current collector and drying and pressing the resulting product.

Example cathode active materials may comprise a lithium-containing transition metal oxide. In an embodiment, the transition metal may be Co, Ni, Mn, or a combination thereof. A metal oxide may be utilized to coat the lithium-containing transition metal oxide. In some embodiments, other lithium-containing transition metals can be utilized instead of, or in addition to, lithium-containing transition metal oxide, for example, lithium-containing transition metal sulfides, selenides, halides, or any combination thereof.

Example anode active materials may include a carbonaceous material, for example, low-crystalline or high-crystalline carbon. Exemplary low-crystalline carbon materials are soft carbon and hard carbon. Exemplary high-crystalline carbon materials are high-temperature sintered carbon, such as natural graphite, artificial graphite, kish graphite, pyrolytic carbon, mesophase pitch based carbon fiber, meso-carbon microbeads, mesophase pitches, and petroleum or coal tar pitch derived cokes. Example anode active materials may include a lithium metal, silicon, or tin. Example anode active materials allow intercalation and deintercalation of lithium ions.

When a binder is used, the binder may bind an active material. The binder may be any binders in common use for lithium secondary batteries, for example, polyvinylidene fluoride, polypropylene, carboxymethylcellulose, polyvinylpyrrolidone, tetrafluoroethylene, polyethylene, polyvinyl alcohol, or styrene butadiene rubber.

The all solid-state battery may have any shape, for example, a cylindrical type, a rectangular type, a pouch type, or may be conformable to any shape.

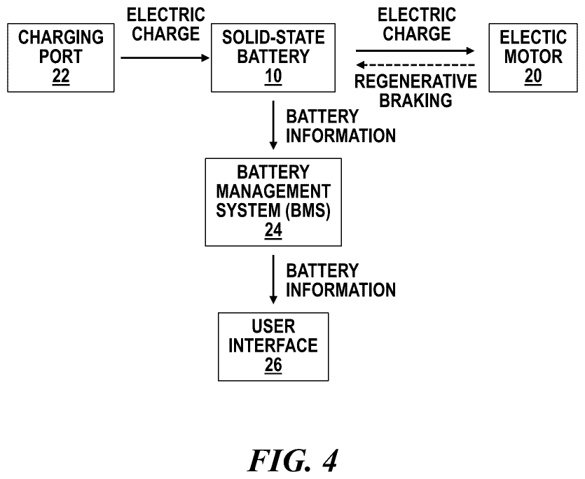

In some embodiments, an electric vehicle is provided. As illustrated schematically in FIG. 4, the electric vehicle comprises an electric motor 20 configured to propel the vehicle, and a solid-state battery 10 comprising an electrolyte material according to the formula Li₂CaCl₄ or Li₃Ca₂Cl₇.

In some embodiment, the electric vehicle further comprises a charging port 22 which is configured to receive power from an external charging station. The charging port 22 is in electrical communication with the solid-state battery 10 and allows the solid-state battery to be charged from the external charging station.

In some embodiments, the electric vehicle may utilize regenerative braking. In such embodiments, the electric motor 20 is configured to act as a generator during a vehicle braking event. Thus, the electric motor 20 charges the solid-state battery 10 during a vehicle braking event.

In some embodiments, the solid-state battery may be integrated into a load-bearing member of the electric vehicle, such as a vehicle floor plan.

In some embodiments, the electric vehicle may further comprise a battery management system (BMS) 24. This BMS 24 is in electrical communication with the solid-state battery 10 and is configured to receive information from the battery to monitor a state of charge of the solid-state battery, the temperature of the solid-state battery, and/or the voltage of the solid-state battery. In some embodiments, the electric vehicle may further comprise a user interface 26 for displaying battery information from the BMS 24 to a driver. For instance, the user interface 26 may display the state of charge of the battery, the battery temperature, and/or the estimated range of the vehicle.

With further reference to the flow chart of FIG. 2, in some embodiments, a method of making an electrolyte material is provided, comprising the steps of solid-phase mixing LiCl and CaCl₂, sintering the mixture under an inert atmosphere, and optionally compressing the electrolyte material into a pellet.

The amount of these precursors to be combined in the initial mixing step will depend upon the final electrolyte material desired. To produce a Li₂CaCl₄ electrolyte, LiCl and CaCl₂ are mixed in a molar ratio of 2:1. To produce a Li₃Ca₂Cl₇ electrolyte, LiCl and CaCl₂ are mixed in a molar ratio of 3:2.

In some embodiments, the solid-phase mixing may be performed by mechanical milling, e.g., selected from ball mill, vibration mill, turbo mill, mechanofusion, and disk mill. In an embodiment, the solid-phase mixing may be desirably performed by ball mill. In some embodiments, the milling is performed for between about 4 to about 50 hours, about 8 hours to about 25 hours, or about 10 hours to about 14 hours. In some embodiments, the ball milling is performed at about 150 rpm to about 600 rpm, about 200 rpm to about 400 rpm or about 250 rpm.

In some embodiments, the sintering is performed at between about 300 °C and 1000 °C, between about 500 °C and 1000 ° ° C. In some embodiments, sintering is performed for about 1 to about 24 hours, or about 6 to about 12 hours.

In some embodiments, the powder material obtained after sintering may be compressed to produce a pelleted material. For instance, the powder may be compressed using a hydraulic press. Further heating may also be applied as the material is compressed.

Various examples and experimental examples of the present invention will be described in detail. However, the following examples are merely some examples of the present invention, and the present invention should not be construed as being limited to the following examples.

### Examples

A series of Li₂CaCl₄ and Li₃Ca₂Cl₇ compounds were prepared. The materials were synthesized by solid-state synthesis according to the process described above.

The Li₂CaCl₄ and Li₃Ca₂Cl₇ materials so prepared were then analyzed to determine the space group of the crystalline structure, the Li ion diffusion activation energy (Eₐ), the Li ion conductivity (σ) at 300 K, the energy above hull (Ehull), and Vickers hardness. The results are summarized in Table 1 below.

TABLE 1
Li₂CaCl₄ and Li₃Ca₂Cl₇ solid electrolytes

| | | | | | Ehull | |
|---|---|---|---|---|---|---|
| Sample | | space | Eₐ | σ (300K) | (meV/ | Hardness |
| No. | Formula | group | (eV) | (mS/cm) | atom) | (GPa) |
| 1 | Li₂CaCl₄ | Cm | 0.21 | 45.072 | 34.9 | 1.53 |
| 2 | Li₂CaCl₄ | Imma | 0.19 | 50.559 | 29 | 0.43 |
| 3 | Li₂CaCl₄ | Cmmm | 0.17 | 46.383 | 68.3 | 0.27 |
| 4 | Li₃Ca₂Cl₇ | P1 | 0.18 | 53.649 | 25.1 | 0.68 |

As can be seen in Table 1, each of the samples had a space group of Cm, Imma, Cmmm, or P1. The Ea values ranged from about 0.17 eV to about 0.21 eV, which indicates that ions in the material can readily move within the material. The conductivity values ranged from about 45 to about 55 mS/cm, which indicates good conductivity, and low impedance, when used as a battery electrolyte. The Eₕᵤₗₗ values ranged from about 25 to about 70 meV/atom, indicating good thermodynamic stability or metastability. The hardness values ranged from about 0.25 to about 1.6 GPa, which shows that the material is soft and readily deformable.

The foregoing is illustrative of the present invention and is not to be construed as limiting thereof. The invention is defined by the following claims, with equivalents of the claims to be included therein. All publications, patent applications, patents, patent publications, and other references cited herein are incorporated by reference in their entireties for the teachings relevant to the sentence and/or paragraph in which the reference is presented.

1. An electrolyte material according to the formula Li₂CaCl₄ or the formula Li₃Ca₂Cl₇, wherein the electrolyte material crystallizes in a space group selected from the group consisting of Cm, Imma, Cmmm, and P1.

2. The electrolyte material of claim 1, wherein the electrolyte material has a conductivity of at least 10 millisiemens/centimeter (mS/cm) at a temperature of 300 K.

3. The electrolyte material of claim 1, wherein the electrolyte material has an energy above hull from about 25 meV/atom to about 70 meV/atom.

4. The electrolyte material of claim 1, wherein the electrolyte material has a Vickers hardness from about 0.25 GPa to about 1.6 GPa.

5. A solid-state battery, comprising an electrolyte material according to the formula Li₂CaCl₄ or the formula Li₃Ca₂Cl₇, wherein the electrolyte material crystallizes in a space group selected from the group consisting of Cm, Imma, Cmmm, and P1.

6. The solid-state battery of claim 5, wherein the electrolyte material has a conductivity of at least 10 millisiemens/centimeter (mS/cm) at a temperature of 300 K.

7. The solid-state battery of claim 5, wherein the electrolyte material has an energy above hull from about 25 meV/atom to about 70 meV/atom.

8. The solid-state battery of claim 5, wherein the electrolyte material has a Vickers hardness from about 0.25 GPa to about 1.6 GPa.

9. The solid-state battery of claim 5, comprising a positive electrode, a negative electrode and the electrolyte material between the positive electrode and the negative electrode.

10. An electric vehicle, comprising an electric motor configured to propel the vehicle, and the solid-state battery of claim 5.

11. The electric vehicle of claim 10, wherein the motor is configured to act as a generator during a vehicle braking event to charge the solid-state battery.

12. The electric vehicle of claim 10, further comprising a charging port in electrical communication with the solid-state battery, the port configured to receive power from an external charging station.

13. The electric vehicle of claim 10, wherein the solid-state battery is integrated into a load-bearing structural member of the electric vehicle.

14. The electric vehicle of claim 10, further comprising a battery management system (BMS) in electrical communication with the solid-state battery, the BMS configured to monitor a state of charge, temperature, and voltage of the battery.

15. The electric vehicle of claim 14, further comprising a user interface for displaying battery information from the BMS to a driver, including at least one of state of charge, estimated vehicle range, and battery temperature.

16. A method of making a Li₃Na₂Br₅ or Li₂Na₃Br₅ electrolyte material, comprising:
mixing LiBr and NaBr, and
sintering the mixture to thereby produce the Li₂CaCl₄ or Li₃Ca₂Cl₇electrolyte material.

17. The method of claim 16, further comprising compressing the electrolyte material into a pellet.

18. The method of claim 16, wherein the sintering is performed at 500 °C to 1000 °C for about 6 to about 12 hours.

19. The method of claim 16, wherein the electrolyte material has a conductivity of at least 10 millisiemens/centimeter (mS/cm) at a temperature of 300 K.

20. The method of claim 16, wherein the electrolyte material has an energy above hull from about 25 meV/atom to about 70 meV/atom.

21. (canceled)
